(19) United States
(12) Patent Application Publication
(10) Pub. No.: US 2006/0265539 A1
(43) Pub. Date: Nov. 23, 2006

(54) Method and system for supplying electric power by PCMCIA socket

(75) Inventors: Yu-Cheng Hua, Taipei Hsien (TW); Wei-Che Lin, Taipei Hsien (TW)

Correspondence Address: BACON & THOMAS, PLLC, 625 SLATERS LANE, FOURTH FLOOR, ALEXANDRIA, VA, 22314, US

(73) Assignee: Wistron Corporation, Taipei Hsien (TW)

(21) Appl. No.: 11/242,800

(22) Filed: Oct. 5, 2005

(30) Foreign Application Priority Data
May 17, 2005 (TW) 0942115949

(51) Int. Cl. G06F 13/00

(52) U.S. Cl. 710/302

(57) ABSTRACT

This invention provides a method for supplying electric power by a PCMCIA socket connecting to a PCMCIA controller, the method comprising: determining whether the PCMCIA socket electronically connects to a specific device; determining whether the specific device comprises a PCMCIA interface IC; and if the specific device does not comprise the PCMCIA interface IC therein, then switching on the PCMCIA socket for electric power through the PCMCIA controller to supply electric power to the specific device by the PCMCIA socket.

### BACKGROUND OF THE INVENTION

1. Field of the Invention

This invention relates to an application of a PCMCIA socket, in particular, to a method and a system for supplying electric power by the PCMCIA socket.

2. Description of the Related Art

The standard of the PCMCIA (Personal Computer Memory Card Interface Association) card (or PC card for short) was established in June of 1998 by the Association, which has become a standard of an expanded PC peripheral to promote interchangeability among laptops computer. Due to the limited size host of a laptop computer, a user has to frequently connect the laptop to various peripherals for expanding functions of the laptop computer. Therefore, the PC card has become the best useful interface for connecting the laptop computer to PC peripherals.

Nowadays, the most crucial functions of PC card have evolved continuously as a modem card or a LAN card for the laptop computer, to allow the user being free from carrying heavy peripheral devices with the laptop computer. It is rather convenient for the user to exchange PC cards without restarting the laptop computer, so as to make use of the functions of the PC card to achieve the objective of working in a mobile office.

Generally, a standard PCMCIA card (including modem card, LAN card, memory card, HDD card, etc.) comprises a PCMCIA interface IC therein. Meanwhile, almost each laptop computer has equipped with a PCMCIA interface socket, which connects to a PCMCIA controller inside of the laptop computer. Therefore, if the standard PCMCIA card is inserted into and connected to the standard PCMCIA interface socket, the PCMCIA interface IC is able to provide data for the PCMCIA controller, thereby enabling the PCMCIA controller to identify the connected PCMCIA card, in addition, enabling the host of the laptop computer to supply electric power to the connected PCMCIA card and to retrieve data.

In other words, if the user wants to utilize electric power of the PCMCIA interface socket, the user must insert the PCMCIA card with the PCMCIA interface IC based on the foundation of prior technology. If the user inserts a device having the same appearance and shape of the PCMCIA card and having same pins' location but having no PCMCIA interface IC, the host of the laptop computer is unable to supply electric power to the device without the PCMCIA interface IC, so it may relatively decrease the utilization of the PCMCIA interface socket.

For example, Taiwan Patent Application NO. 92200894, entitled “Wireless remote control stored in a PCMCIA socket of a notebook computer”, has disclosed that the PCMCIA socket may have another function for storing. Nevertheless, the notebook computer still can't have connection electrically to the wireless remote control, not even to mention for charging the wireless remote control. Hence, the wireless remote control is still required a battery to provide electric power for the use of the wireless remote control, it will reduce the convenience of utilization of the wireless remote control.

Moreover, the PCMCIA socket may have additional expandability. For example, the applicant of this invention also filed another Taiwan Patent Application NO. 93221124, entitled “Wireless Handset for VoIP”, which has disclosed the PCMCIA socket may be used to connect with the wireless handset for VoIP. It is to be understood that it would be more convenient to have electric power through the PCMCIA socket supplied by the notebook computer.

### SUMMARY OF THE INVENTION

In view of the foregoing drawbacks, this invention is described herein to provide a method and a system for supplying electric power by a PCMCIA socket. It can switch on the PCMCIA socket for electric power that is controlled by a PCMCIA controller of a computer for supplying electric power.

First, the system provided by this invention enables the PCMCIA socket to supply electric power. The system comprises the PCMCIA socket, the PCMCIA controller, a memory, and a processor, wherein the PCMCIA controller electronically connects to the PCMCIA socket and the processor, respectively, and the memory electronically connects to the processor. When a specific device is inserted into the PCMCIA socket, the processor according to the present invention then implement a computer program stored in the memory to access bits data in an ExCA (Exchangeable Card Architecture) Interface Status Register, a CardBus Socket Present-State Register, and/or an ExCA Power Control Register of the PCMCIA controller, so as to achieve the objective of supplying electric power to the specific device by way of the PCMCIA socket.

Subsequently, the method provided by the present invention for supplying electric power by the PCMCIA socket comprises:

determining whether the PCMCIA socket electronically connects to the specific device;

determining whether the specific device comprises the PCMCIA interface IC when the PCMCIA socket electronically connects to the specific device; and

switching on the PCMCIA socket for electric power through the PCMCIA controller to supply electric power to the specific device by the PCMCIA socket when the specific device does not comprise the PCMCIA interface IC therein.

One embodiment of the present invention discloses that the ExCA Interface Status Register comprises a bit 2 and a bit 3; meanwhile, the step of determining whether the PCMCIA socket electronically connects to the specific device further comprises: determining whether the bit 2 and the bit 3 of the ExCA Interface Status Register are both “1”; if YES, determining whether the PCMCIA socket is switched on for electric power; and if the PCMCIA socket is not switched on for electric power, the determination is that the specific device is electronically connected to the PCMCIA socket.

Another embodiment of the present invention discloses that the ExCA Interface Status Register further comprises a bit 6, thereby the step of determining whether the PCMCIA socket is switched on for electric power can be determined by whether a value of the bit 6 is “0”; if the bit 6 is “0”, it presumes that the PCMCIA socket is not switched on for electric power thereof.

Another embodiment of the present invention discloses the step of determining whether the specific device comprises a PCMCIA interface IC that can be determined by determining if there is a child device under the PCMCIA controller; if there is no child device under the child device, it represents that the specific device is not a standar PCMCIA device, thereby the specific device is determined not comprising the PCMCIA interface IC.

Another embodiment of the invention shows that the CardBus Socket Present-State Register comprises a bit 4, a bit 5, a bit 10, and a bit 11, in addition, the ExCA Power Control Register comprises a bit 4 and a bit 3. The step of switching on the PCMCIA socket for electric power through the PCMCIA controller to supply electric power further comprises the following steps of: determining if values of the bit 4 and the bit 10 of the CardBus Socket Present-State Register are both “1”; if YES, setting values of the bit 4 and the bit 3 of the ExCA Power Control Register to be “1” and “0”, respectively, for switching on the PCMCIA socket for 5.0V electric power.

Alternatively, another embodiment of the invention shows that the step of switching on the PCMCIA socket for electric power by the PCMCIA controller further comprises the following steps of: determining if values of the bit 5 and the bit 11 of the CardBus Socket Present-State Register are both “1”; if YES, setting the bit 4 and the bit 3 of the ExCA Power Control Register to be both “1”, for switching on the PCMCIA socket for 3.3V electric power.

### BRIEF DESCRIPTION OF THE DRAWINGS

FIG. 1 is a schematic diagram showing a system of supplying electric power by a PCMCIA socket according to the present invention;

FIG. 2 is a schematic diagram of a PCMCIA controller according to the present invention;

FIG. 3 is a flowchart showing a method of supplying electric power by the PCMCIA socket according to the present invention;

FIGS. 4A and 4B are flowcharts showing the method of supplying electric power by the PCMCIA socket according to one embodiment of the invention; and

FIGS. 5A and 5B are flowcharts showing the method of supplying electric power by the PCMCIA socket according to another embodiment of the invention.

### DETAILED DESCRIPTION OF THE PREFERRED EMBODIMENT

The following descriptions of the preferred embodiments are provided to help understand the features and structure of the present invention.

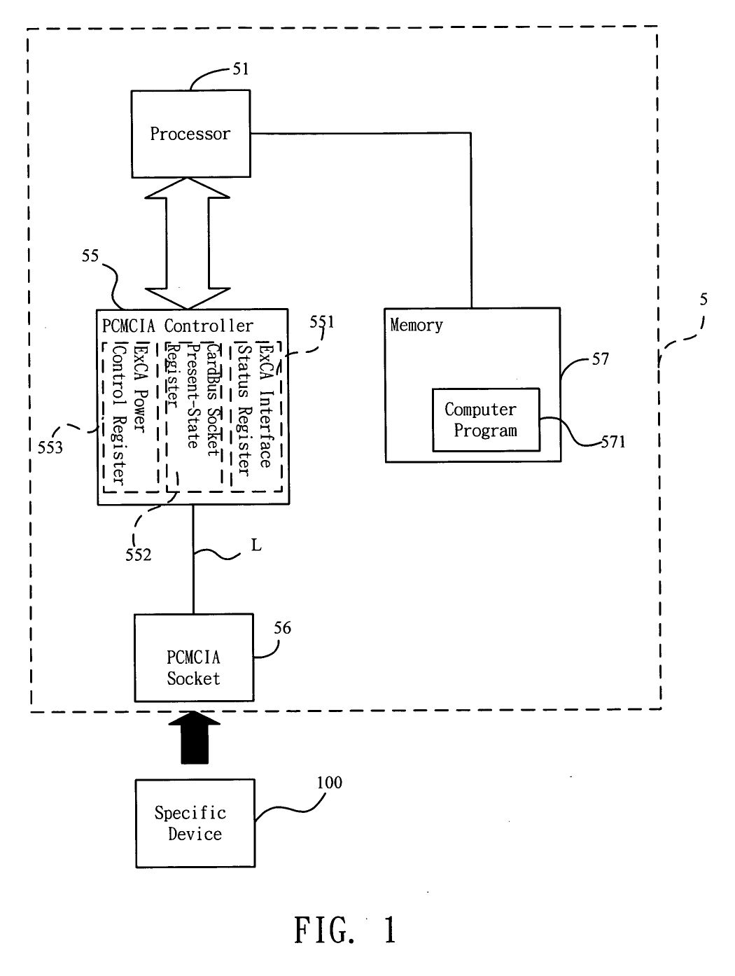

First, the present invention provides a system of supplying electric power by a PCMCIA socket. FIG. 1 shows a schematic diagram of the system of supplying electric power by the PCMCIA socket 56 according to the present invention.

As shown in FIG. 1, the system of the invention is applied to a computer 5 (such as a laptop computer or a notebook computer) to supply electric power by the PCMCIA socket 56 to an external specific device 100. The term of “specific device” 100 means a device that can be inserted into and electronically connected to the PCMCIA socket 56. Nevertheless, based on the prior technology, the specific device 100 can be any device, such as a PCMCIA device without a PCMCIA interface IC, that the PCMCIA socket 56 is unable to supply electric power to.

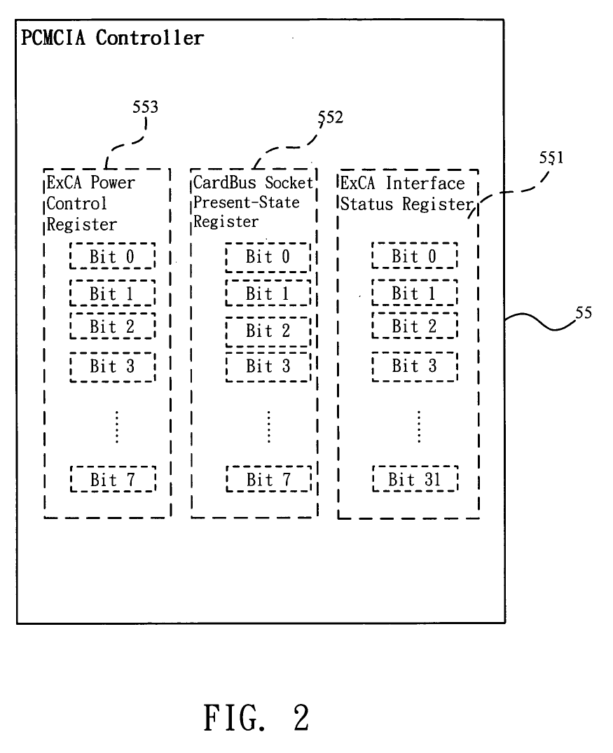

As shown in FIG. 1, when the specific device 100 is inserted into the PCMCIA socket 56, a connection line L is adapted to provide data signals to a PCMCIA controller 55, then a processor 51 implements a computer program 571 stored in a memory 57 to access bits (shown in FIG. 2) in an ExCA Interface Status Register 551, a CardBus Socket Present-State Register 552 and/or an ExCA Power Control Register 553 in the PCMCIA controller 55, so as to achieve the objective of supplying electric power to the specific device 100 by the PCMCIA socket 56.

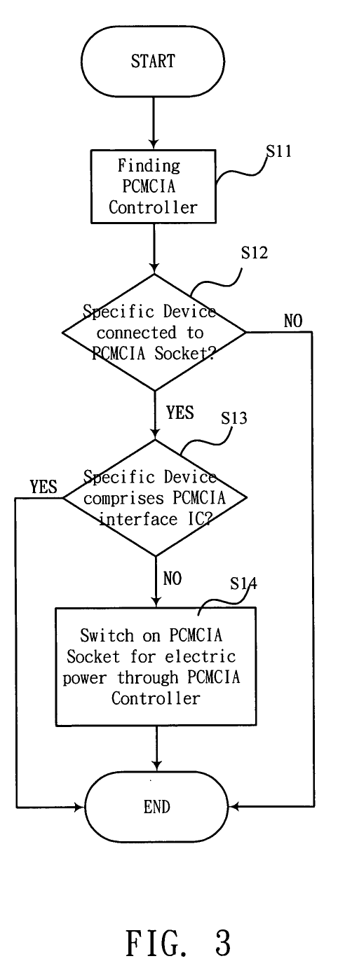

Subsequently, the invention provides a method of supplying electric power by the PCMCIA socket 56, which can be applied to the system of FIG. 1. FIG. 3 is a flowchart showing the method of supplying electric power to the specific device 100 by the PCMCIA socket 56 according to the present invention.

First, in the flowchart of FIG. 3, the step S11 depicts with finding the PCMCIA controller 55. One preferred embodiment of the invention utilizes a WIN32 API (Application Programming Interface) program or utilizes I/O system to detect PCI bus (not shown) of the computer 5 to find out the PCMCIA controller 55.

Subsequently, the flowchart of the FIG. 3 comes to the step S12 that determines whether the PCMCIA socket 56 electronically connects to the specific device 100. In the step S12, the invention determines whether the PCMCIA socket 56 electronically connects to the specific device 100 according to whether the specific device 100 is inserted into the PCMCIA socket 56.

If the PCMCIA socket 56 does not electronically connect to the specific device 100, ended the flowchart. On the contrary, if the PCMCIA socket 56 electronically connects to the specific device 100, the flowchart of FIG. 3 goes to the step S13 for determining whether the specific device 100 comprises the PCMCIA interface IC.

If the specific device 100 comprises the PCMCIA interface IC, ended the flowchart of FIG. 3. On the contrary, if the specific device 100 does not comprise the PCMCIA interface IC, the flowchart of FIG. 3 goes to the step S14 for switching on the PCMCIA socket 56 by the PCMCIA controller 55 to supply electric power to the specific device 100 through the PCMCIA socket 56.

It can be found from the steps S11 to S14 that the invention enables the computer 5 to supply electric power to the specific device 100 (such as the PCMCIA device without the PCMCIA interface IC) by the PCMCIA socket 56, as shown in FIG. 1.

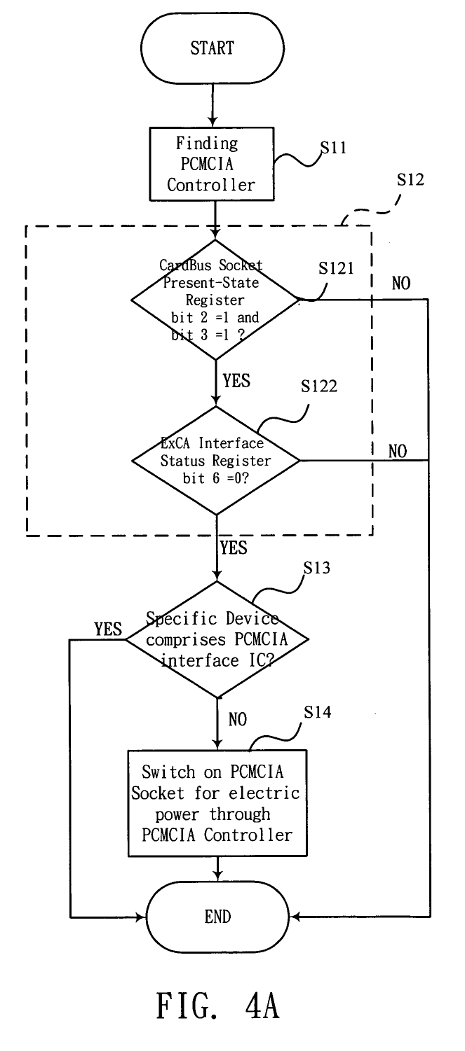

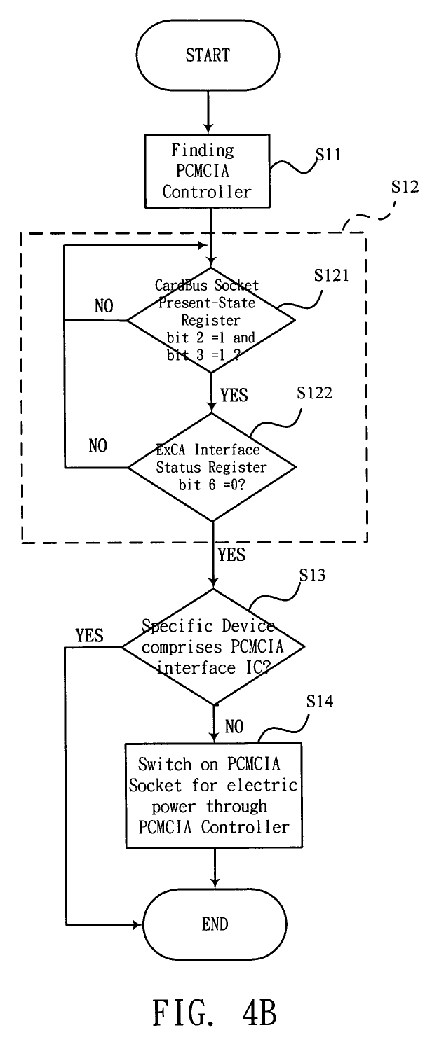

The step S12 is further described as follows, with reference to FIGS. 2, 4A, and 4B.

As shown in FIG. 2, one embodiment of the invention shows that the PCMCIA controller 55 comprises the ExCA Interface Status Register 551, wherein the ExCA Interface Status Register 551 comprises thirty two (32) bits that are respectively indicated as bit 0, bit 1, . . . and bit 31. As shown in FIG. 4A or 4B, the step S12 in the preferred embodiment of the invention further comprises the steps S121 and S122.

First, the flowchart of FIG. 4A or 4B goes to the step S121 for determining whether the values of the bit 2 and the bit 3 of the ExCA Interface Status Register 551 are both “1” (i.e., bit 2=1 and bit 3=1). If the determination of the step S121 is “YES” (bit 2=1 and bit 3=1), it means that an external PCMCIA device is inserted into and connected to the PCMCIA socket 56. Nevertheless, it is necessary to have a further determination for that whether the external PCMCIA device is a standard PCMCIA device or the specific device 100 of the present invention.

The flowchart of FIG. 4A or 4B goes to the step S122 for determining whether bit 6 of the ExCA Interface Status Register 551 is “0”. If the determination is “YES” (bit 6=0), it means that the PCMCIA socket 56 is not switched on for electric power.

If the PCMCIA socket 56 electronically connects to the standard PCMCIA device (such as the PCMCIA device having the PCMCIA interface IC), the PCMCIA socket 56 is switched on automatically, and the value of the bit 6 of the ExCA Interface Status Register 551 is “1”. Therefore, when the PCMCIA socket 56 electronically connects to the external PCMCIA device as long as the PCMCIA socket 56 is not switched on for electric power, the PCMCIA socket 56 electronically connects to the specific device 100 of the invention (i.e. the external PCMCIA device is the specific device 100 without the PCMCIA interface IC).

As shown in FIG. 4A, in one embodiment of the present invention, it shows that whenever the determination of the step S121 or the step S122 is “NO”, the process comes to end. If the determination of the step S121 and the step S122 both are “YES”, it presumes that the specific device 100 is inserted into and electrically connected to the PCMCIA socket 56. The flowchart of FIG. 4A goes to the step S13.

Alternatively, in another embodiment of the present invention, if the determination of the step S121 or the step S122 is “NO”, as shown in FIG. 4B, the flowchart of the present invention repeats the step S12 on regular time intervals, such as in every two seconds, until the determination of the step S121 and the step S122 both are “YES”, so as to ensure that the specific device 100 is inserted into and electrically connected to the PCMCIA socket 56. Subsequently, the flowchart goes to the step S13.

In one preferred embodiment of the invention, the determination of the step S13 can be made by determining if there is any child device under the PCMCIA controller 55. If there is any child under the PCMCIA controller 55, subsequently, there will have signal connection between the PCMCIA controller 55 and the standard PCMCIA device in the PCMCIA socket 56 through the connection L; if so, it shows that the PCMCIA device in the PCMCIA socket 56 is the standard PCMCIA device with the standard PCMCIA interface IC. In other words, if there is no child device under the PCMCIA controller 55, there will be no signal connection to connect with the child device through the connection L. Under this situation (no child device), therefore, the non-standard PCMCIA device (such as the specific device 100) inserted into the PCMCIA socket 56 is not the standard PCMCIA device, i.e. without comprising the PCMCIA interface IC.

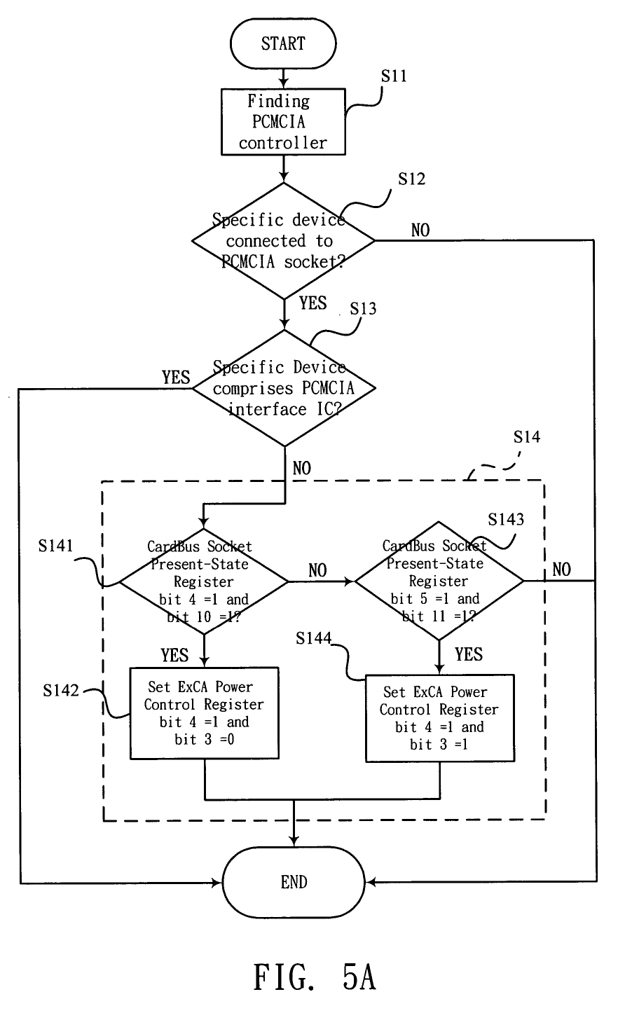

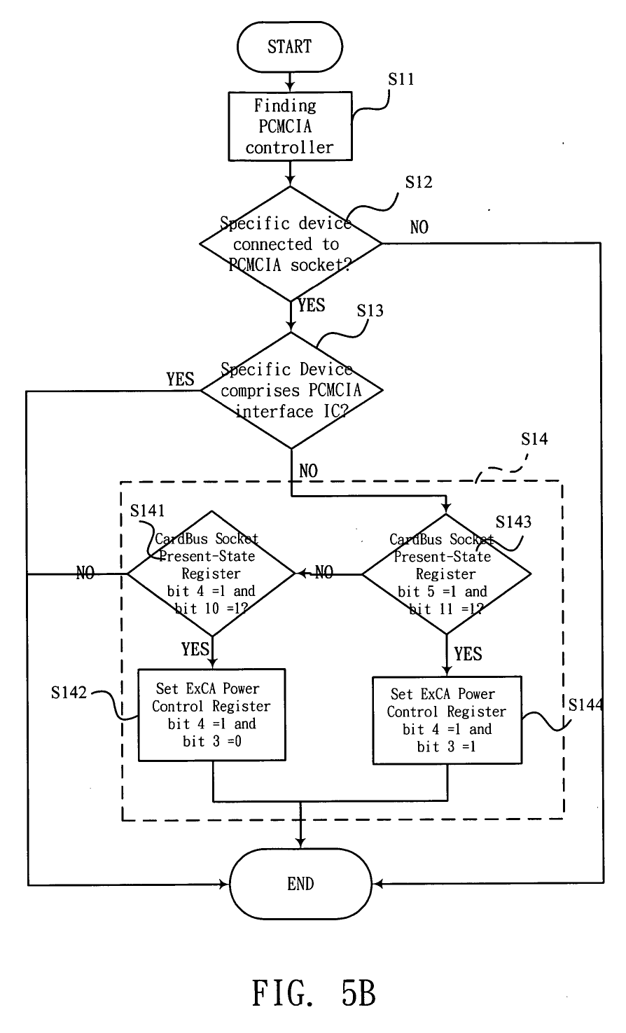

With reference to FIGS. 2, 5A and 5B, the step S14 is further described below in details.

As shown in FIG. 2, another embodiment of the invention shows that the PCMCIA controller 55 comprises the CardBus Socket Present-State Register 552, wherein the CardBus Socket Present-State Register 552 comprises 8 bits, which is respectively indicated as bit 0, bit 1, . . . and bit 7. In addition, the PCMCIA controller 55 further comprises the ExCA Power Control Register 553, wherein the ExCA Power Control Register 553 comprises 8 bits, which is respectively indicated as bit 0, bit 1, . . . and bit 7.

As shown in FIGS. 5A and 5B, two embodiments of the invention show that the step S14 further comprises the steps S141, S142, S143 and S144.

With reference to FIG. 5A, the flowchart goes to the step S141 after step S13 determining with NO. In step S141, the present invention determines whether the values of the bit 4 and the bit 10 of the CardBus Socket Present-State Register are both “1” (bit 4=1 and bit 10=1). If the determination is “YES”, it means that the specific device 100 inserted into the PCMCIA socket 56 is a 16-bit device with an operation voltage of 5.0V. The flowchart goes to the step S142, which is setting the bit 4 of the ExCA Power Control Register 553 as “1” and the bit 3 as “0” (bit 4=1 and bit 3=0) to switch on the PCMCIA socket 56 for 5.0V electric power.

If the determination of the step S141 is “NO”, the flowchart goes to the step S143 for determining whether the values of the bit 5 and the bit 11 of the CardBus Socket Present-State Register 552 are both “1” (bit 5=1 and bit 11=1). If the determination is “YES”, it means that the specific device 100 inserted into the PCMCIA socket 56 is a 32-bit CardBus device with an operation voltage of 3.3V. Next, the flowchart goes to the step S144, which is setting the values of the bit 4 and the bit 3 of the ExCA electric Power Control Register 553 as “1” (bit 4=1 and bit 3=1) to switch on the PCMCIA socket 56 for 3.3V electric power. If the determination of the step S143 is “NO”, the flowchart of FIG. 5A comes to end.

Alternatively, with reference to FIG. 5B, the flowchart may goes to the step S143 before the step S141 determines, wherein the step S143 is described as above. After the step S13 with “NO”, it comes to step S143 first. If the determination of the step S143 is “YES”, the flowchart of FIG. 5B goes to the step S144. If the determination of the step S143 in this embodiment is “NO”, the flowchart of FIG. 5B goes to the step S141. If the determination of the step S141 is “YES”, the flowchart of FIG. 5B goes to the step S142. If the determination of the step S141 in this embodiment is “NO”, the flowchart comes to end.

Although the present invention has been explained in relation to its preferred embodiment, it is to be understood that many other possible modifications and variations can be made without departing from the spirit and scope of the invention as hereinafter claimed.

What is claimed is:

1. A method for supplying electric power by a PCMCIA socket connecting to a PCMCIA controller, the method comprising:
determining whether the PCMCIA socket electronically connects to a specific device;
determining whether the specific device comprises a PCMCIA interface IC; and
if the specific device does not comprise the PCMCIA interface IC therein, then switching on the PCMCIA socket for electric power through the PCMCIA controller to supply electric power to the specific device by the PCMCIA socket.

2. The method of claim 1, wherein the step of determining whether the PCMCIA socket electronically connects to the specific device further comprises finding the PCMCIA controller.

3. The method of claim 1, wherein the PCMCIA controller comprises an ExCA Interface Status Register having a bit 2 and a bit 3, the step of determining whether the PCMCIA socket electronically connects to the specific device further comprising:
determining whether the values of the bit 2 and the bit 3 of the ExCA Interface Status Register are both “1”;
determining whether the PCMCIA socket is switched on for electric power if the values of the bit 2 and the bit 3 are both “1”; and
if the PCMCIA socket is not switched on for electric power, the determination is that the specific device is electronically connected to the PCMCIA socket.

4. The method of claim 3, wherein the ExCA Interface Status Register further comprises a bit 6, the step of determining whether the PCMCIA socket is switched on for electric power that is determined by whether a value of the bit 6 is “0”; if YES, the determination is that the PCMCIA socket is not switched on for electric power.

5. The method of claim 1, wherein the step of determining whether the specific device comprises the PCMCIA interface IC can be determined by determining if there is any child device under the PCMCIA controller; if NO, the specific device is not a standard PCMCIA device, thereby the specific device is presumed not comprising the PCMCIA interface IC.

6. The method of claim 1, wherein the PCMCIA controller comprises a CardBus Socket Present-State Register having a bit 4 and a bit 10, the step of switching on the PCMCIA socket for electric power through the PCMCIA controller to supply electric power further comprising:
determining whether the values of the bit 4 and the bit 10 of the CardBus Socket Present-State Register are both “1”; if YES, implementing the step of switching on the PCMCIA socket for electric power.

7. The method of claim 6, wherein the PCMCIA controller comprises an ExCA Power Control Register having a bit 4 and a bit 3, the step of switching on the PCMCIA socket for electric power by the PCMCIA controller further comprising:
setting the bit 4 as “1” and the bit 3 as “0” for switching on the PCMCIA socket for 5.0V electric power.

8. The method of claim 1, wherein the PCMCIA controller comprises a CardBus Socket Present-State Register having a bit 5 and a bit 11, the step of switching on the PCMCIA socket for electric power by the PCMCIA controller further comprising:
determining whether the values of the bit 5 and the bit 11 of the CardBus Socket Present-State Register are both “1”; if YES, implementing the step of switching on the PCMCIA socket for electric power.

9. The method of claim 8, wherein the PCMCIA controller comprises an ExCA Power Control Register having a bit 4 and a bit 3, the step of switching on the PCMCIA socket for electric power by the PCMCIA controller further comprising:
setting the bit 4 and the bit 3 both as “1” for switching on the PCMCIA socket for 3.3 V electric power.

10. A system for supplying electric power by a PCMCIA socket, executed by a computer comprising:
a PCMCIA socket;
a PCMCIA controller, electronically connecting to the PCMCIA socket; and
a processor, electronically connecting to the PCMCIA controller to implement for:
determining whether the PCMCIA socket electronically connects to a specific device;
determining whether the specific device comprises a PCMCIA interface IC; and
if the specific device does not comprise the PCMCIA interface IC, switching on the PCMCIA socket for electric power through the PCMCIA controller to supply electric power to the specific device by the PCMCIA socket.

11. The system of claim 10, wherein the processor implements a computer program stored in a memory of the computer for the implementation thereof.

12. The system of claim 11, wherein the PCMCIA controller comprises an ExCA Interface Status Register having a bit 2, a bit 3, and a bit 6 and a CardBus Socket Present-State Register having a bit 4 and a bit 10, when the computer program determines that values of the bit 2, the bit 3, the bit 6, the bit 4, and the bit 10 are “1”, “1”, “0”, “1”, “1”, respectively, the processor switches on the PCMCIA socket for electric power by the PCMCIA controller.

13. The system of claim 12, wherein the PCMCIA controller comprises an ExCA Power Control Register having a bit 4 and a bit 3 to be set as “1” and “0”, respectively, thereby enabling to supply 5.0 V electric power by the PCMCIA socket.

14. The system of claim 11, wherein the PCMCIA controller comprises an ExCA Interface Status Register having a bit 2, a bit 3, and a bit 6 and a CardBus Socket Present-State Register having a bit 5 and a bit 11, when the computer program determines that the bit 2, the bit 3, the bit 6, the bit 5, and the bit 11 are “1”, “1”, “0”, “1”, “1”, respectively, the processor switches on the PCMCIA socket for electric power by the PCMCIA controller.

15. The system of claim 14, wherein the PCMCIA controller comprises an ExCA Power Control Register having a bit 4 and a bit 3 to be set as “1”, thereby enabling to supply 3.3V electric power by the PCMCIA socket
